(19) United States
(12) Patent Application Publication
(10) Pub. No.: US 2019/0130863 A1
(43) Pub. Date: May 2, 2019

(54) TOP-ALIGNMENT VERTICAL ALIGNMENT FRINGE IN-PLANE SWITCHING (VA-FIS) LIQUID CRYSTAL DISPLAY

(71) Applicants: a.u. Vista, Inc., Milpitas, CA (US); University of Central Florida Research Foundation, Inc., Orlando, FL (US)

(72) Inventors: Hai-Wei Chen, Orlando, FL (US); Shin-Tson Wu, Oviedo, FL (US); Ming-Chun Li, Hsin-Chu (TW); Seok-Lyul Lee, Hsin-Chu (TW)

(21) Appl. No.: 15/796,070

(22) Filed: Oct. 27, 2017

(51) Int. Cl. G09G 3/36; G02F 1/133

(52) U.S. Cl. CPC G09G 3/3696; G02F 1/13306

(57) ABSTRACT

A liquid crystal display includes: an upper substrate and a lower substrate spaced apart from each other, forming a cell gap therebetween. A liquid crystal layer is disposed in the cell gap between the upper substrate and the lower substrate and has liquid crystal molecules. A common electrode is disposed on the lower substrate facing the liquid crystal layer. A passivation layer is disposed on the lower substrate and covers the common electrode. Multiple pixel electrodes are disposed on the passivation layer. A planar electrode is disposed on the upper substrate facing the liquid crystal layer, and is provided with a first biased voltage. The liquid crystal molecules of the liquid crystal layer are vertically aligned at a voltage-off state. In some cases, the upper substrate has a first anchoring energy W₂ and the lower substrate has a second anchoring energy W₂, and W₂ is weaker than W₁.

### FIELD

The disclosure relates generally to display technology, and more particularly to a top-alignment vertical alignment fringe in-plane switching (VA-FIS) liquid crystal display.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A field sequential color (FSC) liquid crystal display (LCD) is a strong contender for next-generation display technology, as it exhibits two major advantages: 3× higher resolution density and 3× higher optical efficiency. These two features are highly desirable for high-end TVs and emerging augmented reality and vertical reality (AR/VR) applications. However, to suppress the color breakup of the FSC LCD, the required response time is quite challenging. Typically, the required response time should be less than 1 ms.

To get sub-millisecond response time, several methods could be employed. For example, the polymer-stabilized blue phase liquid crystal (BPLC) may be employed in the LCD. This mode does not need an alignment layer and its electro-optic performance is insensitive to the cell gap, leading to high fabrication yield. However, the operation voltage is too high, and thin-film transistor (TFT) driving is fairly complicated due to the slow charging time. Another option to get fast response time is to apply an erasing field to accelerate the LC relaxation process, such as triode structure. In this case, experiments have demonstrated that ˜0.1 ms response time may be achieved. Still, the bottleneck is the demanding TFT driving circuit.

Therefore, a heretofore unaddressed need exists in the art to address the aforementioned deficiencies and inadequacies.

### SUMMARY

One aspect of the disclosure relates to a liquid crystal display, which includes: an upper substrate and a lower substrate spaced apart from each other, forming a cell gap therebetween; a liquid crystal layer disposed in the cell gap between the upper substrate and the lower substrate and having liquid crystal molecules, wherein Δε>0; a common electrode disposed on the lower substrate facing the liquid crystal layer; a passivation layer disposed on the lower substrate and covering the common electrode; a plurality of pixel electrodes disposed on the passivation layer; and a planar electrode disposed on the upper substrate facing the liquid crystal layer, wherein the planar electrode is configured to be provided with a first biased voltage, the common electrode is configured to be provided with a second biased voltage, and an absolute value of the second biased voltage is smaller than an absolute value of the first biased voltage; and wherein the liquid crystal molecules of the liquid crystal layer are vertically aligned at a voltage-off state.

In certain embodiments, the liquid crystal display is switchable from the voltage-off state to a voltage-on state by applying on-state voltages to the pixel electrodes, wherein for the pixel electrodes in the voltage-on state, the on-state voltages applied to two adjacent ones of the pixel electrodes are in different polarities.

In certain embodiments, the first biased voltage and the second biased voltage are in different polarities. In one embodiment, the first biased voltage is a positive voltage, and the second biased voltage is a negative voltage.

In certain embodiments, the liquid crystal display further includes a first alignment layer disposed on the upper substrate facing the liquid crystal layer, wherein the first alignment layer has a first anchoring energy W₁, and is configured to induce vertical alignment of the liquid crystal molecules in the voltage-off state.

In certain embodiments, no alignment layer is disposed on the lower substrate.

In certain embodiments, the first anchoring energy W₁ is in a range of about 10⁻³ to 10⁻² N/m.

In certain embodiments, the liquid crystal display further includes a second alignment layer disposed on the lower substrate facing the liquid crystal layer, wherein the second alignment layer has a second anchoring energy W₂, and the second anchoring energy W₂ is weaker than the first anchoring energy W₁.

In certain embodiments, the first anchoring energy W₁ is in a range of about 10⁻³ to 10⁻² N/m, and the second anchoring energy W₂ is in a range of about 10⁻⁶ to 10⁻⁵ N/m.

In another aspect, a liquid crystal display includes: an upper substrate and a lower substrate spaced apart from each other, forming a cell gap therebetween; a liquid crystal layer disposed in the cell gap between the upper substrate and the lower substrate and having liquid crystal molecules; a common electrode disposed on the lower substrate facing the liquid crystal layer; a passivation layer disposed on the lower substrate and covering the common electrode; a plurality of pixel electrodes disposed on the passivation layer; and a planar electrode disposed on the upper substrate facing the liquid crystal layer, wherein the planar electrode is configured to be provided with a first biased voltage being greater than 0; wherein the upper substrate has a first anchoring energy W₂ and the lower substrate has a second anchoring energy W₂, and the second anchoring energy W₂ is weaker than the first anchoring energy W₁.

In certain embodiments, no alignment layer is disposed on the lower substrate.

In certain embodiments, the liquid crystal molecules of the liquid crystal layer are vertically aligned at a voltage-off state.

In certain embodiments, the liquid crystal display is switchable from the voltage-off state to a voltage-on state by applying on-state voltages to the pixel electrodes, wherein for the pixel electrodes in the voltage-on state, the on-state voltages applied to two adjacent ones of the pixel electrodes are in different polarities.

In certain embodiments, the first biased voltage is about 3 V to 7 V.

In certain embodiments, the common electrode is configured to be provided with a second biased voltage, and the second biased voltage is not equal 0.

In certain embodiments, the common electrode is configured to be provided with a second biased voltage, an absolute value of the second biased voltage is smaller than an absolute value of the first biased voltage, and the first biased voltage and the second biased voltage are in different polarities.

In certain embodiments, the first biased voltage is a positive voltage, and the second biased voltage is a negative voltage.

In certain embodiments, a first alignment layer is disposed on the upper substrate facing the liquid crystal layer, a second alignment layer is disposed on the lower substrate facing the liquid crystal layer, the first alignment layer has the first anchoring energy W₁, and the second alignment layer has the second anchoring energy W₂.

In certain embodiments, the first anchoring energy W₁ is in a range of about 10⁻³ to 10⁻² N/m, and the second anchoring energy W₂ is in a range of about 10⁻⁶ to 10⁻⁵ N/m.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1A schematically shows a liquid crystal display according to certain embodiments of the present disclosure.

FIG. 1B schematically shows a liquid crystal display according to certain embodiments of the present disclosure.

FIG. 1C schematically shows a liquid crystal display according to certain embodiments of the present disclosure.

FIG. 2A schematically shows simulated voltage-to-transmittance curves for VA-FIS LCDs with and without the bottom alignment layer according to certain embodiments of the present disclosure.

FIG. 2B schematically shows simulated time-to-normalized transmittance curves for VA-FIS LCDs with and without the bottom alignment layer according to certain embodiments of the present disclosure.

FIG. 3A schematically shows simulated liquid crystal molecules director distribution for a double-alignment VA-FIS LCD according to certain embodiments of the present disclosure.

FIG. 3B schematically shows simulated liquid crystal molecules director distribution for a top-alignment VA-FIS LCD according to certain embodiments of the present disclosure.

FIG. 4A schematically shows simulated voltage-to-transmittance curves for VA-FIS LCDs with double-alignment, top-alignment, bottom-alignment and no-alignment structures according to certain embodiments of the present disclosure.

FIG. 4B schematically shows simulated time-to-normalized transmittance curves for VA-FIS LCDs with double-alignment, top-alignment, bottom-alignment and no-alignment structures according to certain embodiments of the present disclosure.

FIG. 5A schematically shows simulated voltage-to-transmittance curves for top-alignment VA-FIS LCDs with different biased voltages Vₜₒₚ being applied to the planar electrode according to certain embodiments of the present disclosure.

FIG. 5B schematically shows simulated time-to-normalized transmittance curves for top-alignment VA-FIS LCDs with different biased voltages Vₜₒₚ being applied to the planar electrode according to certain embodiments of the present disclosure.

FIG. 6A schematically shows simulated voltage-to-transmittance curves for top-alignment VA-FIS LCDs with different cell gap thicknesses according to certain embodiments of the present disclosure.

FIG. 6B schematically shows simulated time-to-normalized transmittance curves for top-alignment VA-FIS LCDs with different cell gap thicknesses according to certain embodiments of the present disclosure.

FIG. 7A schematically shows simulated voltage-to-transmittance curves for top-alignment VA-FIS LCDs with different gap distances between the pixel electrodes according to certain embodiments of the present disclosure.

FIG. 7B schematically shows simulated time-to-normalized transmittance curves for top-alignment VA-FIS LCDs with different gap distances between the pixel electrodes according to certain embodiments of the present disclosure.

FIG. 8A schematically shows simulated voltage-to-transmittance curves for top-alignment VA-FIS LCDs with different thicknesses of the passivation layer according to certain embodiments of the present disclosure.

FIG. 8B schematically shows simulated time-to-normalized transmittance curves for top-alignment VA-FIS LCDs with different thicknesses of the passivation layer according to certain embodiments of the present disclosure.

FIG. 9 schematically shows simulated voltage-to-transmittance curves for top-alignment and double-alignment VA-FIS LCDs with the dark state and threshold voltages for different thicknesses of the passivation layer according to certain embodiments of the present disclosure.

FIG. 10A schematically shows simulated liquid crystal molecules director and equipotential line distribution for a double-alignment VA-FIS LCD without a biased voltage according to certain embodiments of the present disclosure.

FIG. 10B schematically shows simulated liquid crystal molecules director and equipotential line distribution for a double-alignment VA-FIS LCD with a biased voltage Vₜₒₚ=4 V according to certain embodiments of the present disclosure.

FIG. 10C schematically shows simulated liquid crystal molecules director and equipotential line distribution for a top-alignment VA-FIS LCD with a biased voltage Vₜₒₚ=4 V and a thicknesses of the passivation layer tₚₐₛₛ=0.1 μm according to certain embodiments of the present disclosure.

FIG. 10D schematically shows simulated liquid crystal molecules director and equipotential line distribution for a top-alignment VA-FIS LCD with a biased voltage Vₜₒₚ=4 V and a thicknesses of the passivation layer tₚₐₛₛ=0.3 μm according to certain embodiments of the present disclosure.

FIG. 10E schematically shows simulated liquid crystal molecules director and equipotential line distribution for a top-alignment VA-FIS LCD with a biased voltage Vₜₒₚ=4 V and a thicknesses of the passivation layer tₚₐₛₛ=0.5 μm according to certain embodiments of the present disclosure.

FIG. 11A schematically shows simulated liquid crystal molecules director and equipotential line distribution for a top-alignment VA-FIS LCD with a biased voltage Vₜₒₚ=4 V, a thicknesses of the passivation layer tₚₐₛₛ=0.5 μm, and a common voltage V_{com}=−0.8 V according to certain embodiments of the present disclosure.

FIG. 11B schematically shows simulated liquid crystal molecules director and equipotential line distribution for a top-alignment VA-FIS LCD with a biased voltage Vₜₒₚ=4 V, a thicknesses of the passivation layer tₚₐₛₛ=0.5 μm, and a common voltage V_{com}=−0.8 V according to certain embodiments of the present disclosure.

FIG. 11C schematically shows simulated voltage-to-transmittance curves for top-alignment VA-FIS LCDs with the dark state and threshold voltages for the conditions as shown in FIGS. 11A and 11B according to certain embodiments of the present disclosure.

FIG. 12 schematically shows simulated voltage-to-transmittance curves for VA-FIS LCDs with different anchoring energies of the lower substrate according to certain embodiments of the present disclosure.

### DETAILED DESCRIPTION OF THE DISCLOSURE

The present disclosure will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top”, and “left” and “right”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

The description will be made as to the embodiments of the present disclosure in conjunction with the accompanying drawings. In accordance with the purposes of this disclosure, as embodied and broadly described herein, this disclosure, in certain aspects, relates to a liquid crystal display (LCD).

Recently, the LCD in a vertical alignment fringe in-plane switching (VA-FIS) mode was proposed and fast response was obtained even at −30° C. In the vertical alignment LCD, the liquid crystal molecules naturally align vertically to the glass substrates. When no voltage is applied, the liquid crystal molecules remain perpendicular to the substrate, creating a black display between crossed polarizers. When voltages are applied, the liquid crystal molecules shift to a tilted position, allowing light to pass through and create a gray-scale display depending on the amount of tilt generated by the electric field. The driving scheme of the VA-FIS LCD is simple and there is no charging issue. However, the trade-offs of the VA-FIS LCD are twofold: increased operation voltage and decreased transmittance. In other words, its operation voltage is too high and transmittance is too low for practical applications. Therefore, there is a great demand to solve these issues.

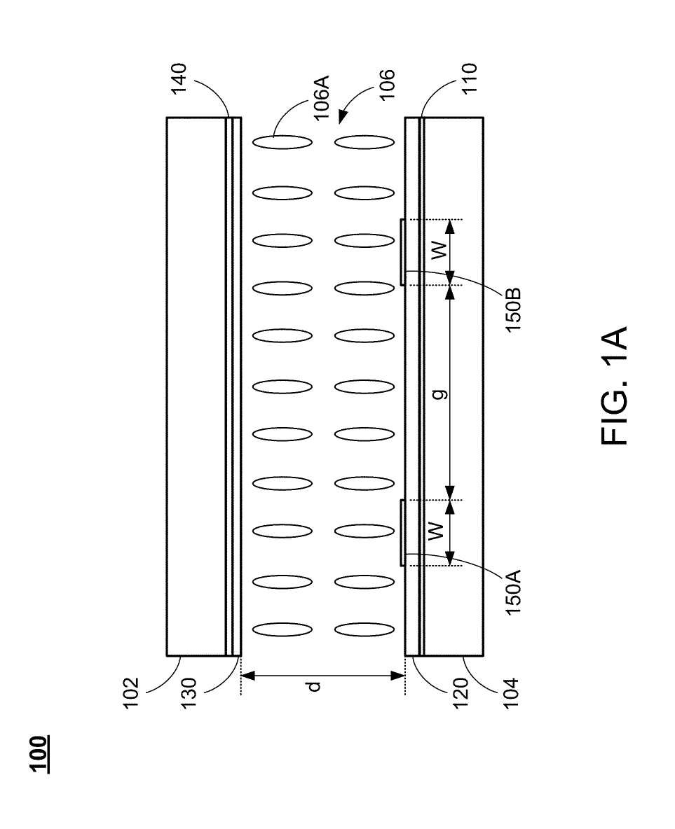

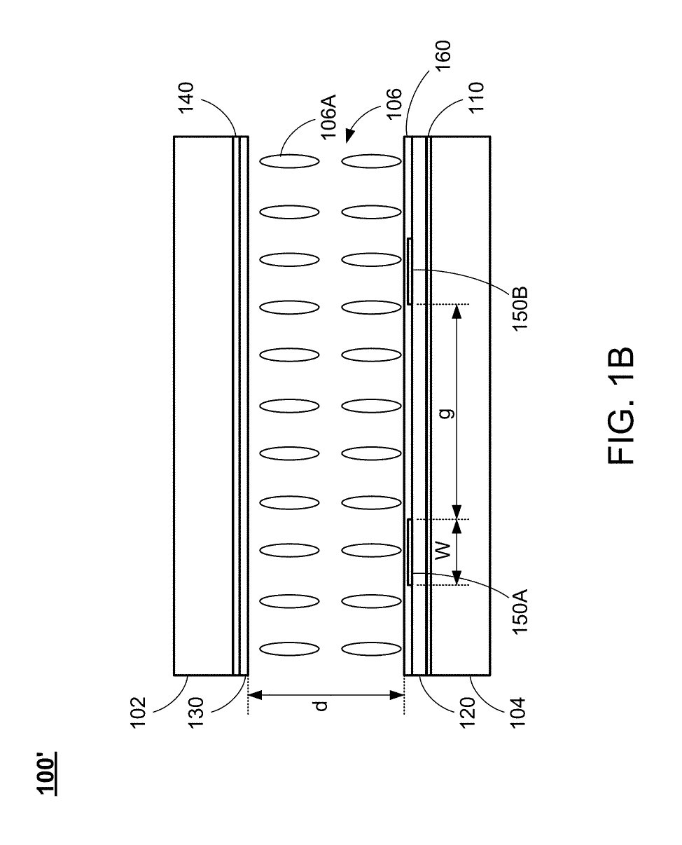

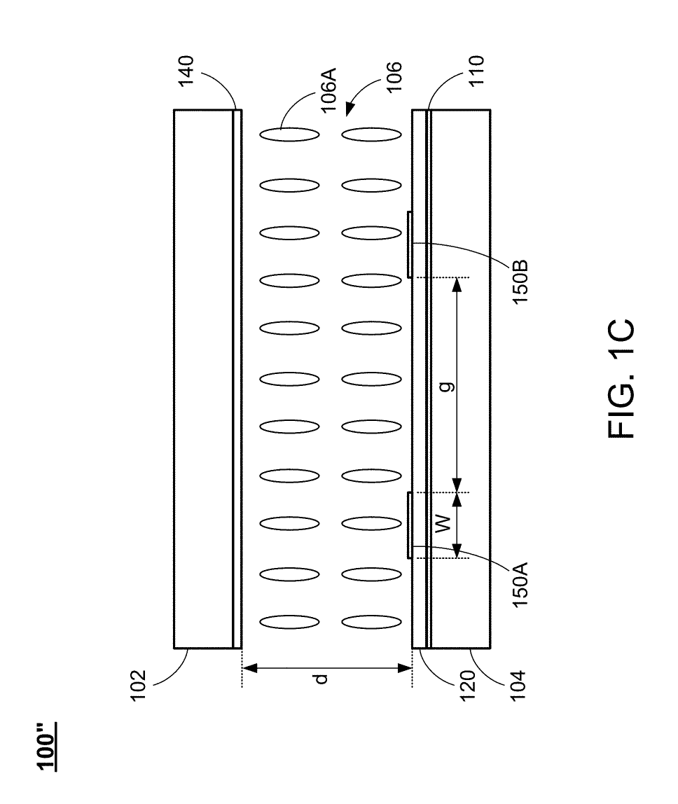

FIG. 1A depicts a schematic view of a liquid crystal display according to certain embodiments of the present application. Specifically, the LCD 100 as shown in FIG. 1A is a top-alignment VA-FIS LCD. As shown in FIG. 1A, the LCD 100 includes an upper substrate 102 and a lower substrate 104, a common electrode 110, a passivation layer 120, a top alignment layer 130, a planar electrode 140, and a plurality of pixel electrodes 150A and 150B adjacent to each other. The upper substrate 102 and the lower substrate 104 are spaced apart from each other, forming a cell gap therebetween. A liquid crystal layer 106 is disposed in the cell gap between the upper substrate 102 and the lower substrate 104 and having liquid crystal molecules 106A. The thickness of the cell gap (i.e., the space where the liquid crystal layer 106 exists) is d. The common electrode 110 is disposed on the lower substrate 104 facing the liquid crystal layer 106, and the passivation layer 120 is disposed on the lower substrate 104 and covering the common electrode 110. The pixel electrodes 150A and 150B are disposed on the passivation layer 120. Each of the pixel electrodes 150A and 150B has a width W, and a gap distance g exists between the adjacent pixel electrodes 150A and 150B. In certain embodiments, W=2 μm, and g=5 μm. The top alignment layer 130 and the planar electrode 140 are disposed on the upper substrate 102 facing the liquid crystal layer 106. Specifically, as shown in FIG. 1A, the planar electrode 140 is directly disposed on the upper substrate 102, and the top alignment layer 130 is disposed on the planar electrode 140. It should be noted that the LCD 100 as shown in FIG. 1A has a top-alignment structure, and as the name indicates, there is only one alignment layer (i.e., the top alignment layer 130) disposed on the upper substrate 102. In other words, no alignment layer is disposed on the lower substrate 104.

In the LCD 100 as shown in FIG. 1A, the planar electrode 140 is provided with a fixed biased voltage Vₜₒₚ, and the common electrode 110 is provided with a common voltage V_{com}. In certain embodiments, Vₜₒₚ is a positive voltage which is greater than 0. In certain embodiments, V_{com}=0. In this case, a strong vertical electric field is generated in the whole panel. Further, the LCD 100 is switchable between a voltage-off state and a voltage-on state. In the voltage-off state, no voltage is applied to the pixel electrodes 150A and 150B. When the LCD 100 is switched from the voltage-off state to the voltage-on state, on-state voltages are applied to the pixel electrodes 150A and 150B, creating a horizontal electric field. This has two effects: (1) the liquid crystal molecules 106A are vertically aligned along the electric field, leading to high contrast ratio; and (2) the liquid crystal molecules are forced to initial state when the horizontal electric field is removed, leading to faster decay time.

The purpose of providing the top alignment layer 130 on the upper substrate 102 is to induce vertical alignment of the liquid crystal molecules 106A of the liquid crystal layer 106 in the voltage-off state. In certain embodiments, the top alignment layer 130 has a first anchoring energy W₁, which may be in a range of about 10⁻³ to 10⁻² N/m.

In certain embodiments, in the voltage-on state, the on-state voltages applied to two adjacent pixel electrodes 150A and 150B are in different polarities. For example, if the on-state voltage being applied to the pixel electrode 150A is +V, the on-state voltage being applied to the pixel electrode 150B is −V. Thus, the strength of horizontal electric field is doubled. This structure is called the FIS mode structure [J W Park, et al. APL 93, 081103 (2008)], since the fringe electric field and the in-plane electric field coexist.

FIG. 1B depicts a schematic view of a liquid crystal display according to certain embodiments of the present application. Specifically, the LCD 100′ as shown in FIG. 1B is a special-top-alignment VA-FIS LCD, which is different from the LCD 100 as shown in FIG. 1A in that the LCD 100′ as shown in FIG. 1B further includes a bottom alignment layer 160 disposed on the lower substrate 104 facing the liquid crystal layer 106. Specifically, the bottom alignment layer 160 is disposed on the passivation layer 120 and the pixel electrodes 150A and 150B. In certain embodiments, the bottom alignment layer 160 has a second anchoring energy W₂, which is weaker than the first anchoring energy W₁ of the top alignment layer 130. In certain embodiments, when the first anchoring energy W₁ of the top alignment layer 130 is in a range of about 10⁻³ to 10⁻² N/m, the second anchoring energy W₂ of the bottom alignment layer 160 may be in a range of about 10⁻⁶ to 10⁻⁵ N/m. Other structures of the LCD 100′ as shown in FIG. 1B, including the upper substrate 102 and the lower substrate 104, the common electrode 110, the passivation layer 120, the top alignment layer 130, the planar electrode 140, and the plurality of pixel electrodes 150A and 150B, are identical to the corresponding structures of the LCD 100 as shown in FIG. 1A, and are thus not elaborated herein.

It should be noted that the “special-top-alignment” structure as shown in FIG. 1B is similar to but slightly different from a “double-alignment” structure. A double-alignment structure may refer to a structure which includes both a top alignment layer and a bottom alignment layer, which is similar to the special-top-alignment structure as shown in FIG. 1B. The difference between the double-alignment structure and the special-top-alignment structure exists in that, in a double-alignment structure, each of the top and bottom alignment layers may have a strong anchoring energy that is not significantly different from the anchoring energy of the other alignment layer. In comparison, as disclosed above, in the special-top-alignment structure as shown in FIG. 1B, the bottom alignment layer 160 has a second anchoring energy W₂, which is weaker than the first anchoring energy W₁ of the top alignment layer 130. In other words, in the special-top-alignment structure, the first anchoring energy W₁ of the top alignment layer 130 is significantly greater than the second anchoring energy W₂ of the bottom alignment layer 160.

FIG. 1C depicts a schematic view of a liquid crystal display according to certain embodiments of the present application. Specifically, the LCD 100″ as shown in FIG. 1B is a no-alignment VA-FIS LCD, which is different from the LCD 100 as shown in FIG. 1A in that the LCD 100″ as shown in FIG. 1C does not include the top alignment layer 130. In other words, the LCD 100″ as shown in FIG. 1C does not include any alignment layer. Other structures of the LCD 100″ as shown in FIG. 1C, including the upper substrate 102 and the lower substrate 104, the common electrode 110, the passivation layer 120, the planar electrode 140, and the plurality of pixel electrodes 150A and 150B, are identical to the corresponding structures of the LCD 100 as shown in FIG. 1A, and are thus not elaborated herein.

There are several factors in determining the performances of the LCD as shown in FIGS. 1A-1C. These factors include, without being limited thereto, an absolute value of the on-state voltage applied to each of the pixel electrodes 150A and 150B; the gap distance g between the two pixel electrodes 150A and 150B; the thickness d of the cell gap; the thickness of the passivation layer 120; the fixed biased voltage Vₜₒₚ applied to the planar electrode 140; and the common voltage applied to the common electrode 110. Analysis of these factors will be described hereinafter in detail.

The inventors have investigated the electro-optical properties of the top-alignment VA-FIS LCD structure using a commercial LCD simulator DIMOS.2D. To perform the simulation, the cell parameters are provided as follows: the pixel electrode width W=2 μm, the gap distance g between the pixel electrodes=5 μm, and cell gap thickness d=4 μm. The material of the liquid crystal molecules used here is a positive Δε LC material with Δn=0.125, Δε=6.7, and γ₁=53 mPas. Further, as discussed above, a fixed biased voltage Vₜₒₚ=4 V is applied to the planar electrode to generate a vertical electric field.

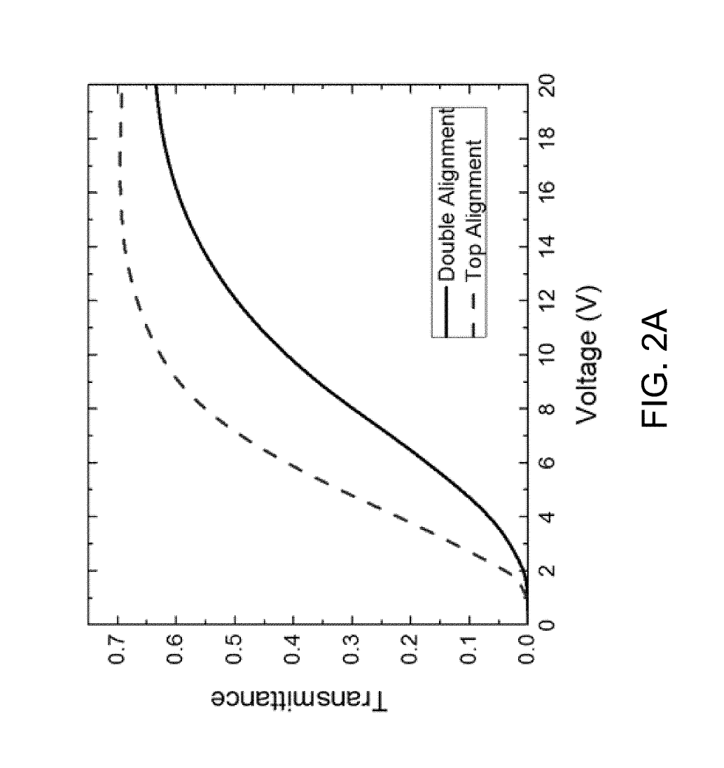

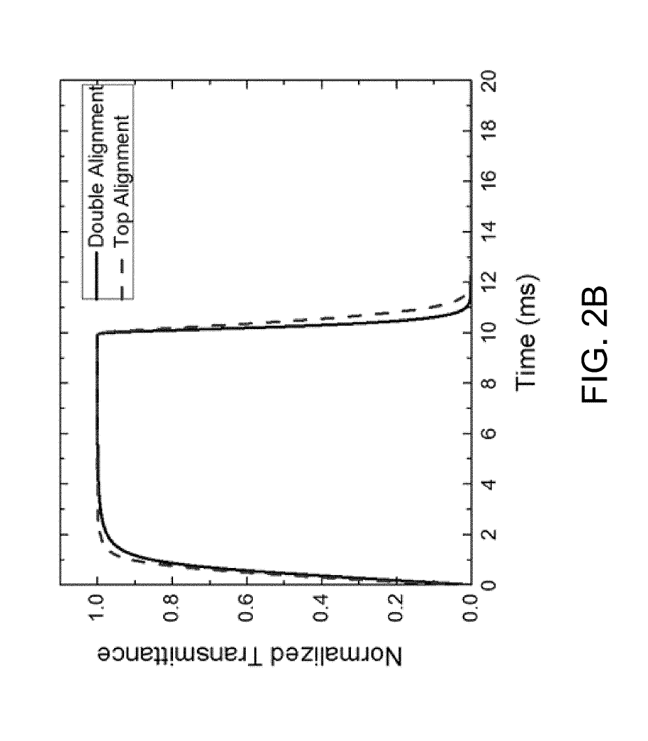

FIG. 2A schematically shows simulated voltage-to-transmittance (VT) curves for VA-FIS LCDs with and without the bottom alignment layer according to certain embodiments of the present disclosure. FIG. 2B schematically shows simulated time-to-normalized transmittance (TT) curves for VA-FIS LCDs with and without the bottom alignment layer according to certain embodiments of the present disclosure. As shown in FIGS. 2A and 2B, the solid lines correspond to the double-alignment VA-FIS LCD, which includes the bottom alignment layer 160, and the dotted lines correspond to the top-alignment VA-FIS LCD, which does not include the bottom alignment layer. As shown in FIG. 2B, in the VA-FIS LCD with double-alignment, the response time is pretty fast (rise time: 1.07 ms, decay time: 0.61 ms). However, as shown in from FIG. 2A, the on-state voltage for the double-alignment VA-FIS LCD is higher than 20 V, and transmittance at 15 V is only 58.0%, which is too low for practical applications. On the other hand, the top-alignment VA-FIS LCD shows significant improvement in comparison to the double-alignment VA-FIS LCD. For example, the VT curve of the top-alignment VA-FIS LCD increases much earlier and faster. Further, the corresponding on-state voltage for the top-alignment VA-FIS LCD is only 17 V, and transmittance at 15 V is as high as 69.3%. Moreover, as shown in FIG. 2B, sub-millisecond response time is realized in the top-alignment VA-FIS LCD (rise time: 0.91 ms, decay time: 0.93 ms).

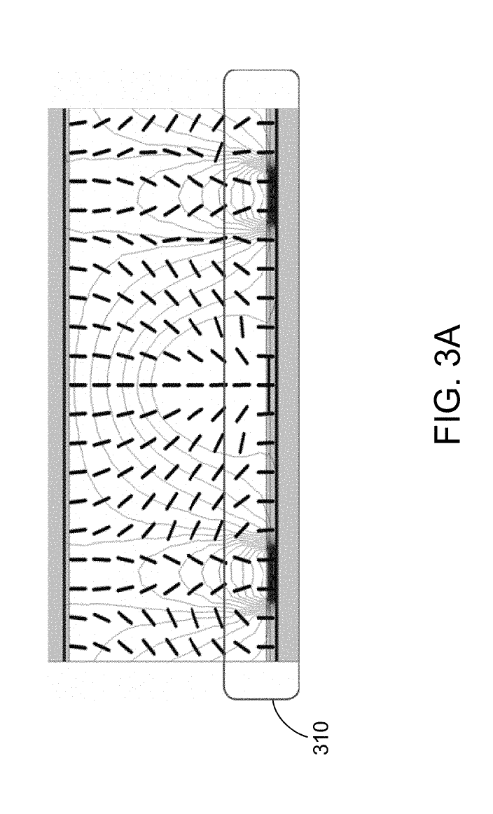

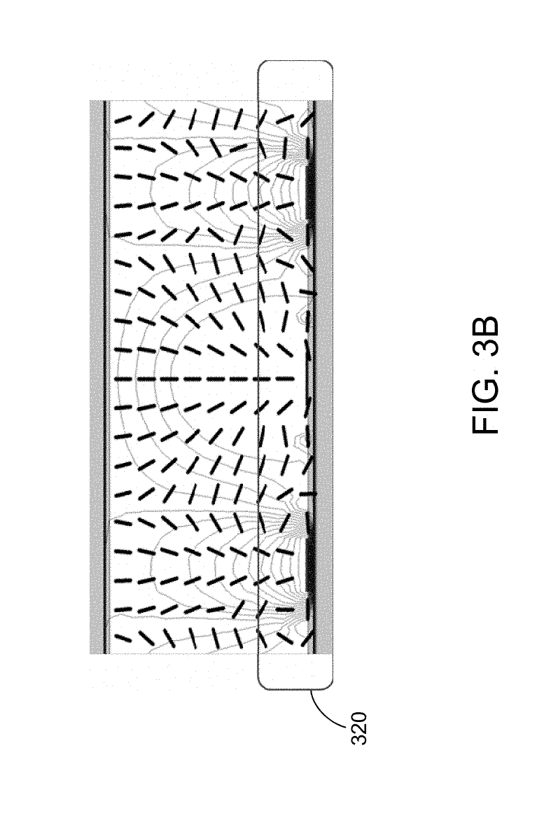

FIG. 3A schematically shows simulated liquid crystal molecules director distribution for a double-alignment VA-FIS LCD according to certain embodiments of the present disclosure. FIG. 3B schematically shows simulated liquid crystal molecules director distribution for a top-alignment VA-FIS LCD according to certain embodiments of the present disclosure. Specifically, the simulation results as shown in FIGS. 3A and 3B are provided for better understanding of the underlying physical mechanisms of the top-alignment and double-alignment VA-FIS LCDs. As shown in FIG. 3A, the LC molecules in the double-alignment VA-FIS LCD near the lower substrate (shown in the area 310) stay still due to the strong anchoring energy. In comparison, in the case of the top-alignment VA-FIS LCD as shown in FIG. 3B, these LC molecules in the same area (shown in the area 320) rotate freely and easily along the electric field. As a result, the phase retardation is larger and required voltage is smaller for the top-alignment VA-FIS LCD.

It should be noted that the top-alignment VA-FIS LCD is not limited to the LCD 100 as shown in FIG. 1A, which includes a top alignment layer 130 but has no alignment layer disposed on the lower substrate 104. For example, a liquid crystal display which includes a bottom alignment layer 160 as shown in FIG. 1B, but has no top alignment layer disposed on the upper substrate 102 is, by definition, also a “single-alignment” VA-FIS LCD, because such LCD also includes only one alignment layer (i.e., the bottom alignment layer 160) disposed on the bottom substrate 104. To distinguish the two types of the single-alignment structures, the LCD 100 as shown in FIG. 1A (which includes a top alignment layer 130 but has no alignment layer disposed on the lower substrate 104) is hereinafter referred to as the “top-alignment” structure, and the other LCD structure (which includes a bottom alignment layer 160 but has no alignment layer disposed on the upper substrate 102) is hereinafter referred to as the “bottom-alignment” structure.

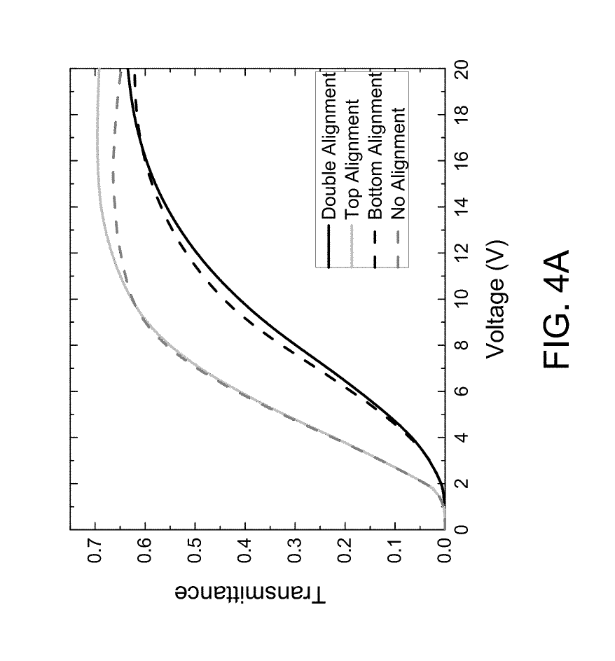

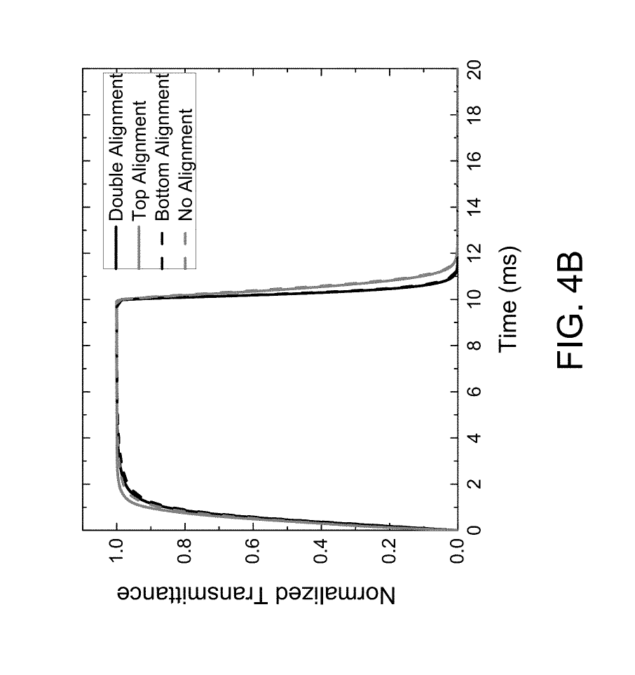

FIG. 4A schematically shows simulated VT curves for VA-FIS LCDs with double-alignment, top-alignment, bottom-alignment and no-alignment structures according to certain embodiments of the present disclosure. FIG. 4B schematically shows simulated time-to-normalized transmittance (TT) curves for VA-FIS LCDs with double-alignment, top-alignment, bottom-alignment and no-alignment structures according to certain embodiments of the present disclosure. Specifically, FIGS. 4A and 4B include the data of all four types of alignment conditions, while FIGS. 2A and 2B include only the data of the double-alignment VA-FIS LCD and the top-alignment VA-FIS LCD. As shown in FIGS. 4A and 4B, the bottom-alignment structure shows almost the same performance as that of the double-alignment structure, although the top alignment layer is removed in the bottom-alignment structure. This is because the liquid crystal molecule reorientations mainly happen near the lower substrate (i.e., the lower side of LC region), which are governed by the bottom alignment layer 160. Then, as expected, once this bottom alignment layer 160 is removed, the device performance would be improved noticeably, as shown by the data of the top-alignment structure (gray solid line) and the no-alignment structure (gray dashed line) in FIG. 4A.

In the analysis performed to obtain the data as shown in FIGS. 2A, 2B, 4A and 4B, the biased voltage Vₜₒₚ applied to the planar electrode 140 is kept at 4 V. Since the fixed biased voltage Vₜₒₚ applied to the planar electrode 140 is also a factor for the performance of the LCD, the inventors have conducted further investigation to tune this biased voltage Vₜₒₚ to investigate how it affects the electro-optical properties.

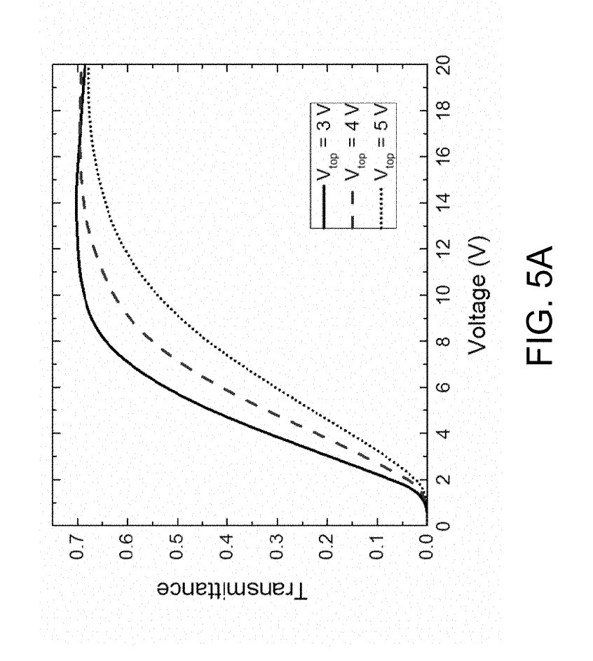

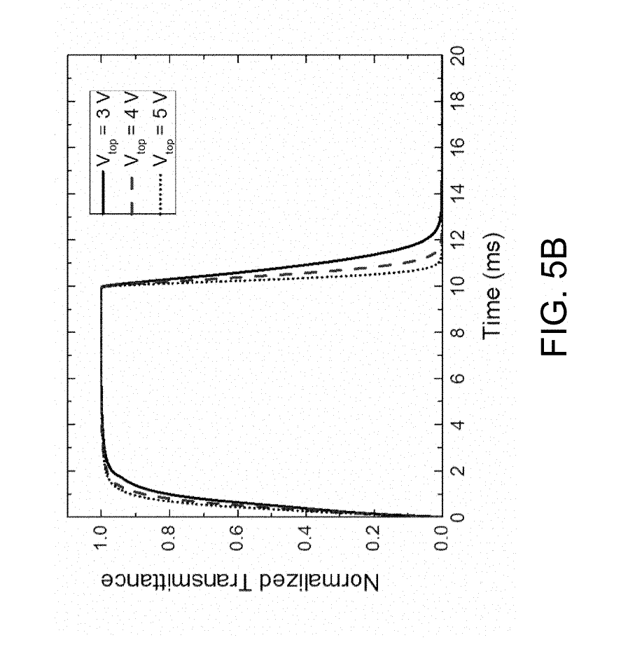

FIG. 5A schematically shows simulated voltage-to-transmittance curves for top-alignment VA-FIS LCDs with different biased voltages Vₜₒₚ being applied to the planar electrode according to certain embodiments of the present disclosure. FIG. 5B schematically shows simulated time-to-normalized transmittance curves for top-alignment VA-FIS LCDs with different biased voltages Vₜₒₚ being applied to the planar electrode according to certain embodiments of the present disclosure. Specifically, FIGS. 5A and 5B show different results for the cases where the biased voltage Vₜₒₚ may be 3 V, 4 V and 5 V. When the biased voltage increases from 3 V to 5 V, the response time becomes much faster as the vertical electric field becomes stronger, as shown in FIG. 5B. However, the tradeoff exists in that the on-state voltage is increased from 14 V to 20 V, and transmittance is slightly decreased from 70.4% to 65.8% at 15 V. To balance all these properties, the inventors chose Vₜₒₚ=4 V as an optimized choice for further analysis, but other optimized value of the biased voltage may be used depending on the physical properties (i.e., Δε and Δn) of the liquid crystal molecules employed. In certain embodiments, the biased voltage Vₜₒₚ being applied to the planar electrode 140 may be in the range of about 3 V to 7 V.

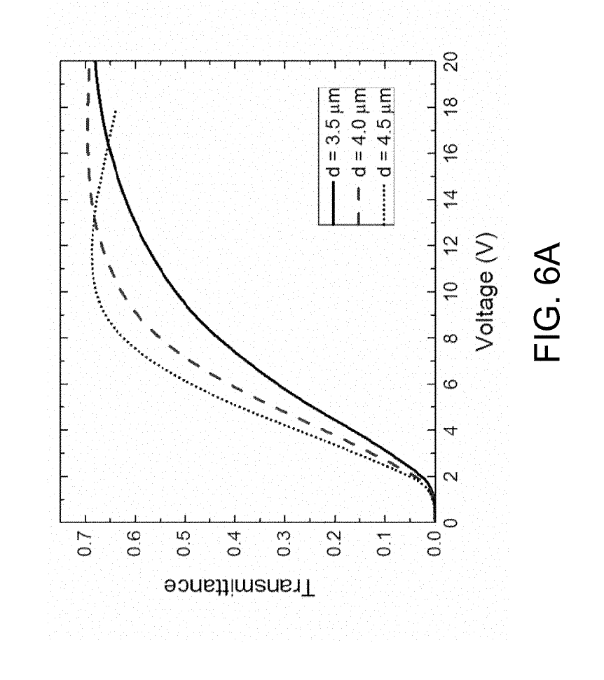

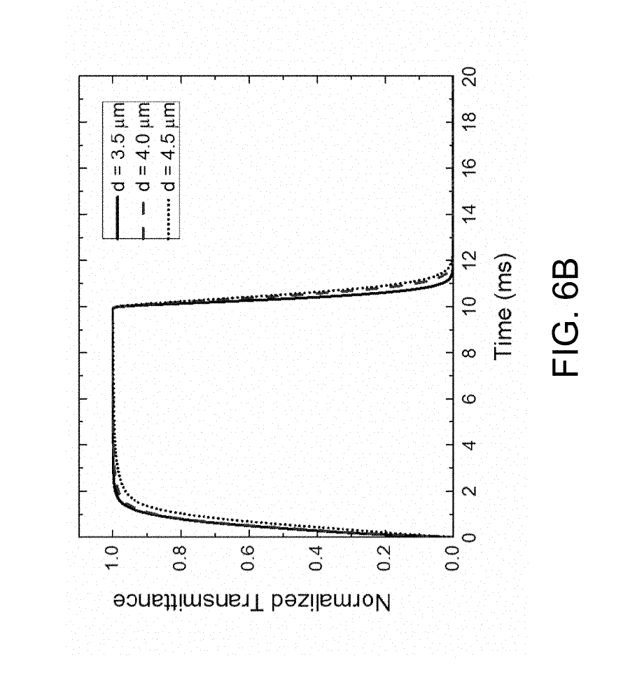

Another factor that determines the performance of the LCD is the thickness d of the cell gap. FIG. 6A schematically shows simulated voltage-to-transmittance curves for top-alignment VA-FIS LCDs with different cell gap thicknesses according to certain embodiments of the present disclosure. FIG. 6B schematically shows simulated time-to-normalized transmittance curves for top-alignment VA-FIS LCDs with different cell gap thicknesses according to certain embodiments of the present disclosure. Specifically, FIGS. 6A and 6B show different results for the cases where the thickness d of the cell gap may be 3.5 μm, 4.0 μm, and 4.5 μm. As shown in FIG. 6B, thin cell gap is more favorable for fast response time, as τ˜d². However, voltage and transmittance would be sacrificed simultaneously. As shown in FIG. 6A, the case where cell gap thickness d=4.5 μm shows the lowest operation voltage (Vₒₙ=11.7 V), but its response time is also the slowest (rise time: 1.27 ms, decay time: 0.99 ms). In real applications, the cell gap thickness d has to be determined carefully. In the following analysis, the thickness d is determined to be 4 μm for further optimizations. In certain embodiments, the thickness d of the cell gap may be in the range of about 2.5 μm to 5 μm.

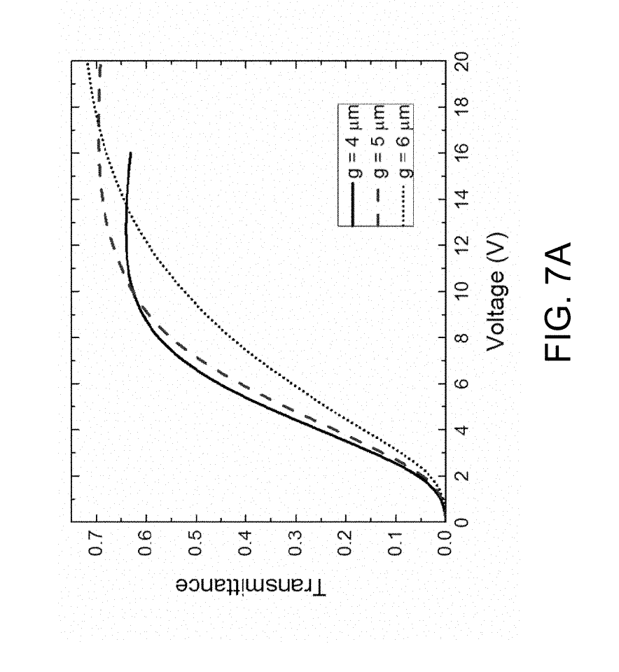

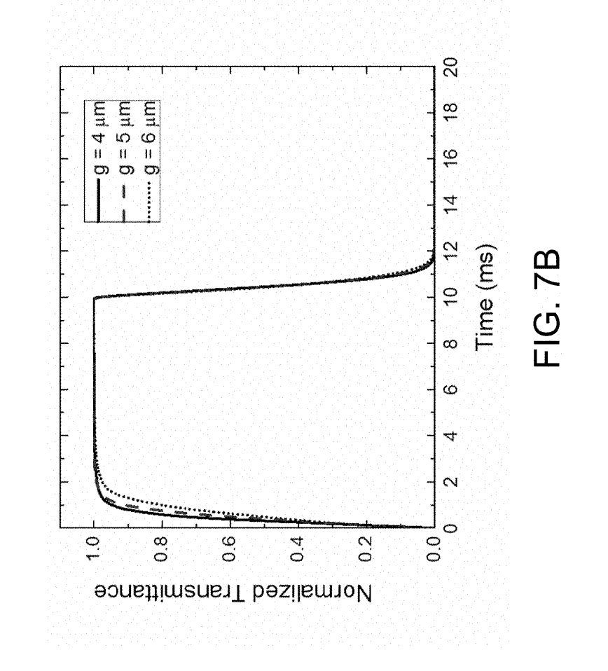

Still another factor that determines the performance of the LCD is the gap distance g between the two pixel electrodes 150A and 150B. FIG. 7A schematically shows simulated voltage-to-transmittance curves for top-alignment VA-FIS LCDs with different gap distances between the pixel electrodes according to certain embodiments of the present disclosure. FIG. 7B schematically shows simulated time-to-normalized transmittance curves for top-alignment VA-FIS LCDs with different gap distances between the pixel electrodes according to certain embodiments of the present disclosure. Specifically, FIGS. 7A and 7B show different results for the cases where the gap distance g between the two pixel electrodes 150A and 150B may be 4 μm, 5 μm, and 6 μm. As shown by the results, a larger electrode gap leads to a higher peak transmittance, but also higher on-state voltage. As shown in FIG. 7A, when the electrode gap distance is increased from 4 μm to 6 μm, peak transmittance is increased from 64.2% to over 70%, but the on-state voltage is also increased from 12.8 V to over 20 V. Using 15 V as a standard on-state voltage, and it is found that the electrode gap distance g=5 μm may be the optimum value. In certain embodiments, the gap distance g between the two pixel electrodes 150A and 150B may be in the range of about 4 μm to 8 μm.

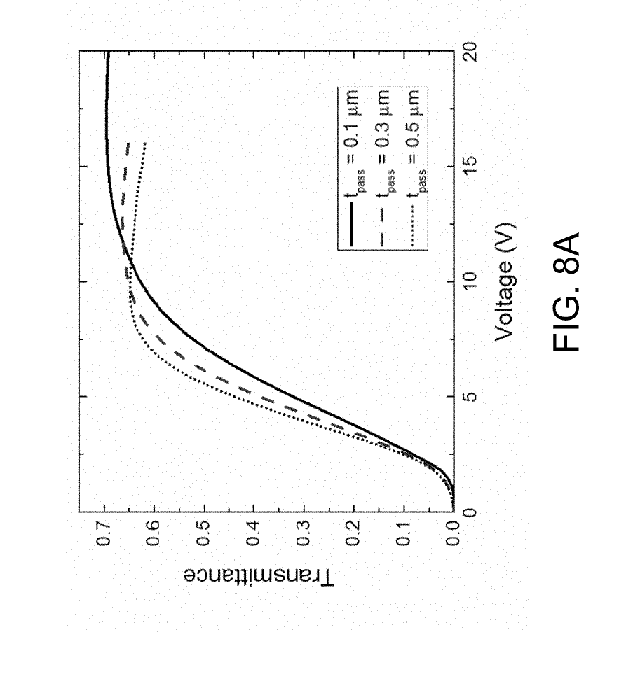

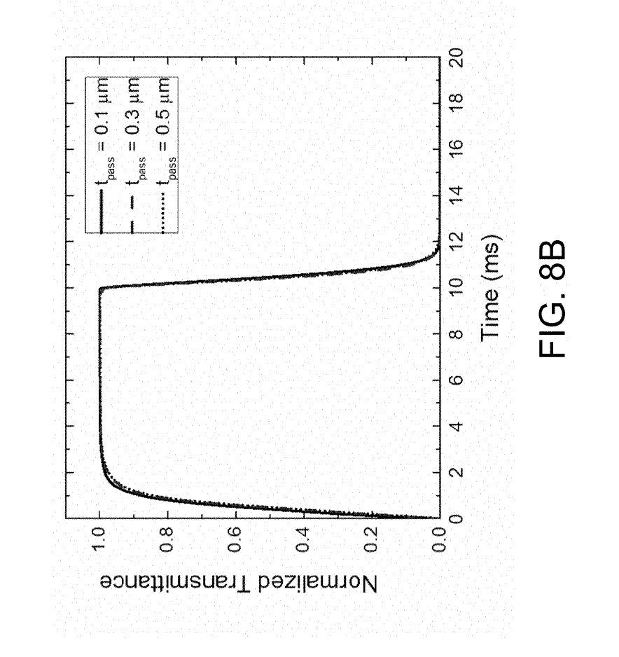

Yet another factor that determines the performance of the LCD is the thickness of the passivation layer 120. FIG. 8A schematically shows simulated voltage-to-transmittance curves for top-alignment VA-FIS LCDs with different thicknesses of the passivation layer according to certain embodiments of the present disclosure. FIG. 8B schematically shows simulated time-to-normalized transmittance curves for top-alignment VA-FIS LCDs with different thicknesses of the passivation layer according to certain embodiments of the present disclosure. Specifically, FIGS. 8A and 8B show different results for the cases where the thickness tₚₐₛₛ of the passivation layer 120 may be 0.1 μm, 0.3 μm, and 0.5 μm. The results show that, as the passivation layer gets thicker, the operation voltage becomes lower, e.g., Vₒₙ=9.6 V for tₚₐₛₛ=0.5 μm. This is because for the unique VA-FIS structure, two forces are competing each other: the vertical electric field and the horizontal electric field. For a thick passivation layer, the corresponding vertical electric field becomes weaker. As a result, the horizontal electric field would dominate and the liquid crystal directors would be reoriented more easily, leading to much lower operation voltage.

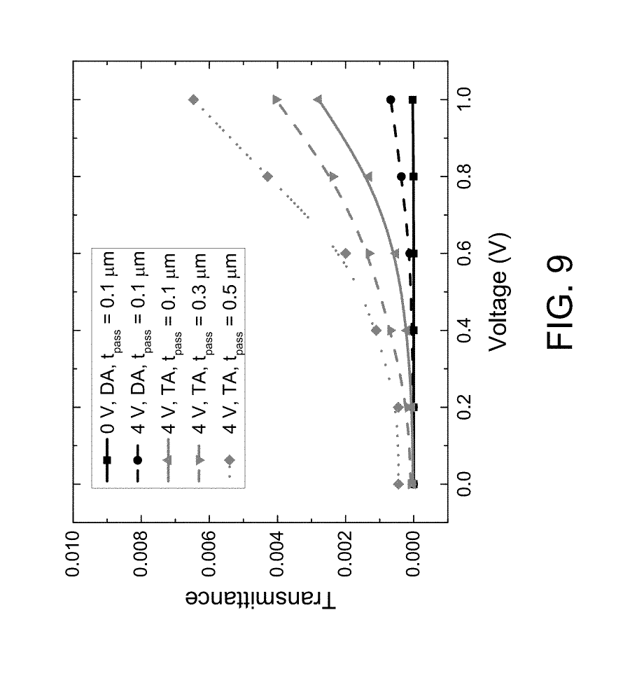

As discussed above, increasing the passivation layer thickness seems to be a good approach to reduce the operation voltage. However, unexpectedly, the dark state and threshold voltage may be sacrificed. FIG. 9 schematically shows simulated voltage-to-transmittance curves for top-alignment (TA) and double- alignment (DA) VA-FIS LCDs with the dark state and threshold voltages for different thicknesses of the passivation layer according to certain embodiments of the present disclosure. As shown in FIG. 9, in a double-alignment VA-FIS LCD, when no biased voltage is applied (black solid line), it shows the best dark state and the highest threshold voltage. This is more favorable for TFT fluctuations. However, when a biased voltage is applied (black dashed line), the threshold voltage is greatly reduced. This is because the threshold state of the liquid crystal directors is already broken by the vertical electric field. Then a very small horizontal electric field would cause these liquid crystal molecules to reorient. Similarly, for the top-alignment case, threshold voltage is further reduced.

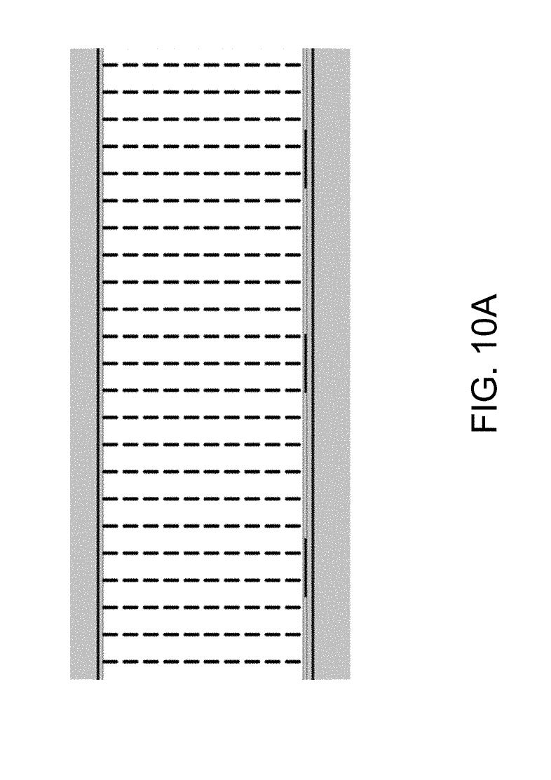

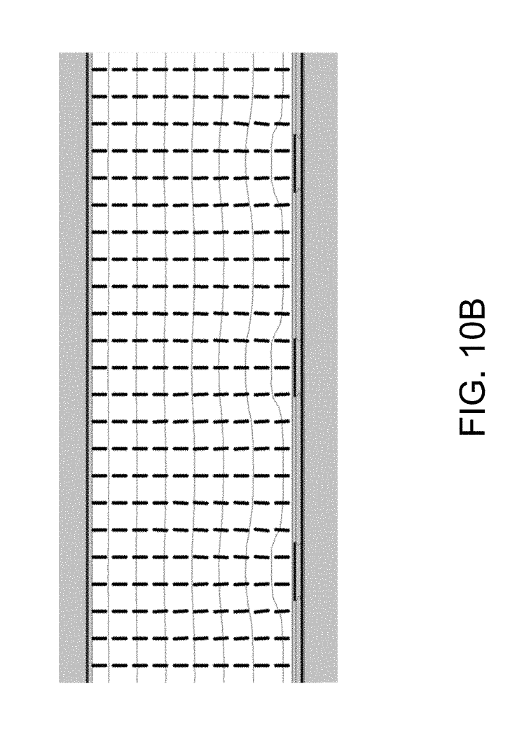

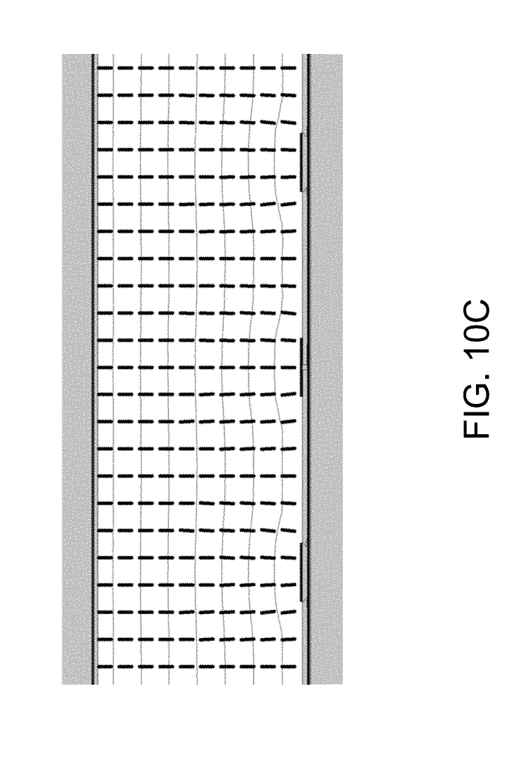

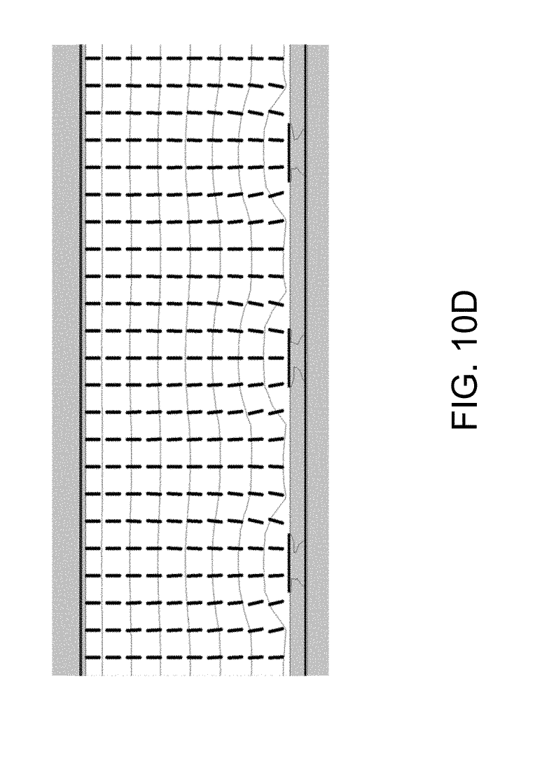

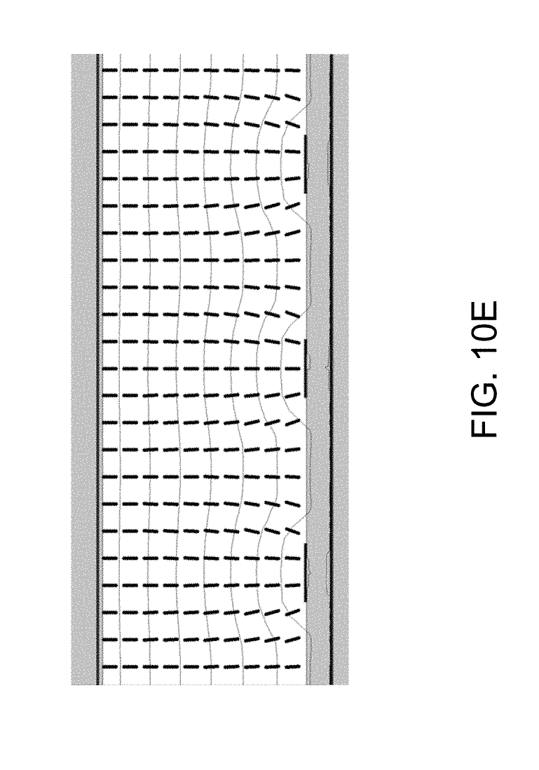

The effect as shown in FIG. 9 could be visualized more clearly in FIGS. 10A-10E. Specifically, FIG. 10A schematically shows simulated liquid crystal molecules director and equipotential line distribution for a double-alignment VA-FIS LCD without a biased voltage according to certain embodiments of the present disclosure. FIG. 10B schematically shows simulated liquid crystal molecules director and equipotential line distribution for a double-alignment VA-FIS LCD with a biased voltage Vₜₒₚ=4 V according to certain embodiments of the present disclosure. FIG. 10C schematically shows simulated liquid crystal molecules director and equipotential line distribution for a top-alignment VA-FIS LCD with a biased voltage Vₜₒₚ=4 V and a thicknesses of the passivation layer tₚₐₛₛ0.1 μm (100 nm) according to certain embodiments of the present disclosure. FIG. 10D schematically shows simulated liquid crystal molecules director and equipotential line distribution for a top-alignment VA-FIS LCD with a biased voltage Vₜₒₚ=4 V and a thicknesses of the passivation layer tₚₐₛₛ=0.3 μm (300 nm) according to certain embodiments of the present disclosure. FIG. 10E schematically shows simulated liquid crystal molecules director and equipotential line distribution for a top-alignment VA-FIS LCD with a biased voltage Vₜₒₚ=4 V and a thicknesses of the passivation layer tₚₐₛₛ=0.5 μm (500 nm) according to certain embodiments of the present disclosure. As shown in FIG. 10A, for the double-alignment case without the biased voltage, no electric field exists and LCs are vertically aligned, showing the best dark state. When a biased voltage is applied, as shown in FIG. 10B, in theory, there should be a vertical electric field. Nevertheless, this field is not perfectly vertical due to the shielding effect of the passivation layer 120. As shown in FIG. 10B, the electric field is slightly slanted. In this case, some LC molecules have already been reoriented, meaning that the threshold state is broken. If the bottom alignment layer is further removed, and the thickness of passivation layer is increased, as shown in FIGS. 10C to 10E, this effect may be magnified. The non-uniformity of the vertical electric field would induce more LC molecules to reorient, and finally, dark state and threshold voltage would be compromised.

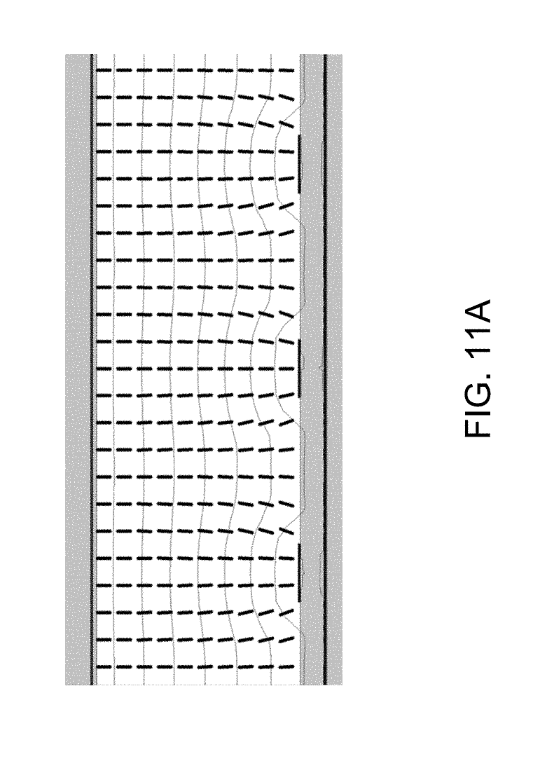

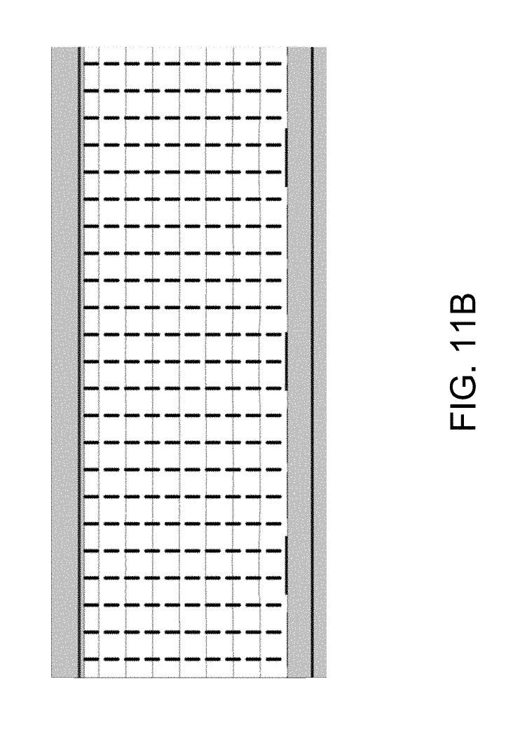

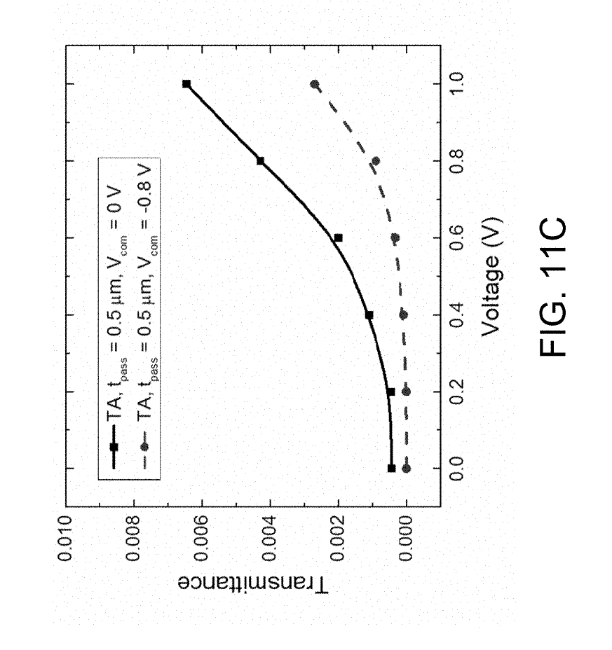

To overcome this light leakage issue, in certain embodiments, a small biased voltage may be applied to the common electrode 110 to compensate the voltage shielding effect of passivation layer 120. In other words, the small biased voltage (i.e., the common voltage V_{com}) applied to the common electrode 110 is not 0, and the absolute value of the common voltage V_{com} is smaller than the absolute value of the biased voltage Vₜₒₚ applied to the planar electrode 140. In certain embodiments, the biased voltage Vₜₒₚ and the common voltage V_{com} are in different polarities. For example, FIG. 11A schematically shows simulated liquid crystal molecules director and equipotential line distribution for a top-alignment VA-FIS LCD with a biased voltage Vₜₒₚ=4 V, a thicknesses of the passivation layer tₚₐₛₛ=0.5 μm, and a common voltage V_{com}=0 V according to certain embodiments of the present disclosure. FIG. 11B schematically shows simulated liquid crystal molecules director and equipotential line distribution for a top-alignment VA-FIS LCD with a biased voltage Vₜₒₚ=4 V, a thicknesses of the passivation layer tₚₐₛₛ=0.5 μm, and a common voltage V_{com}=−0.8 V according to certain embodiments of the present disclosure. FIG. 11C schematically shows simulated voltage-to-transmittance curves for top-alignment VA-FIS LCDs with the dark state and threshold voltages for the conditions as shown in FIGS. 11A and 11B according to certain embodiments of the present disclosure. As shown in FIG. 11B, the common electrode may be applied with a small biased voltage as the common voltage, e.g., V _{com}=−0.8 V. In this case, at the voltage-off state, the resultant electric field is quite uniform, as shown in FIG. 11B. Therefore, both dark state and threshold voltage are improved significantly from the case as shown in FIG. 11A to that as shown in FIG. 11B, as shown in FIG. 11C. It should be noted that the result as shown in FIGS. 11A to 11C are illustrated using the worst case: the top-alignment structure with a thick passivation layer (tₚₐₛₛ=0.5 μm). Undoubtedly, this approach works as well for other conditions, such as a thin passivation layer and the double-alignment structure, where better performance may also be expected.

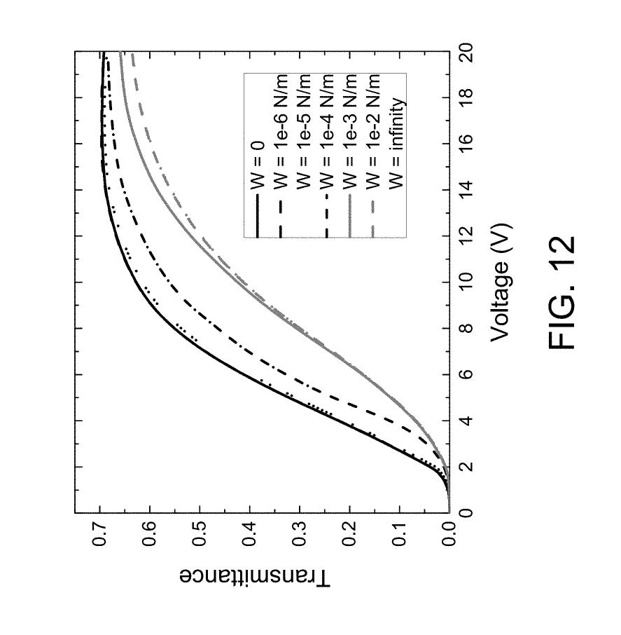

The above analysis and discussions focused on the top-alignment structure, where there is no bottom alignment layer, i.e., the second anchoring energy W₂ is zero. However, in some cases, the bottom alignment layer is still preferred to get better vertical alignment and then higher contrast ratio. With that, the inventor has carried out more investigations on the anchoring energy effect. FIG. 12 schematically shows simulated voltage-to-transmittance curves for VA-FIS LCDs with different anchoring energies of the lower substrate according to certain embodiments of the present disclosure. Specifically, FIG. 12 shows the results for the VA-FIS LCDs, where the second anchoring energies W₂ may be 0, 10⁻⁶ N/m, 10⁻⁵ N/m, 10⁴ N/m, 10⁻³ N/m, 10⁻² N/m, and infinity. As shown in FIG. 12, with the weak anchoring energy (W₂=10⁻⁶˜10⁻⁵ N/m), the performances are almost identical to that of zero anchoring energy, which means the bottom alignment layer is not necessarily removed, as long as the anchoring energy W₂ is weak. Also, as expected, high voltage and low transmittance is obtained with strong anchoring energy (W₂=10⁻³˜10⁻² N/m).

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A liquid crystal display, comprising:
an upper substrate and a lower substrate spaced apart from each other, forming a cell gap therebetween;
a liquid crystal layer disposed in the cell gap between the upper substrate and the lower substrate and having liquid crystal molecules, wherein Δε>0;
a common electrode disposed on the lower substrate facing the liquid crystal layer;
a passivation layer disposed on the lower substrate and covering the common electrode;
a plurality of pixel electrodes disposed on the passivation layer; and
a planar electrode disposed on the upper substrate facing the liquid crystal layer,
wherein the planar electrode is configured to be provided with a first biased voltage, the common electrode is configured to be provided with a second biased voltage, and an absolute value of the second biased voltage is smaller than an absolute value of the first biased voltage; and
wherein the liquid crystal molecules of the liquid crystal layer are vertically aligned at a voltage-off state.

2. The liquid crystal display of claim 1, being switchable from the voltage-off state to a voltage-on state by applying on-state voltages to the pixel electrodes, wherein for the pixel electrodes in the voltage-on state, the on-state voltages applied to two adjacent ones of the pixel electrodes are in different polarities.

3. The liquid crystal display of claim 1, wherein the first biased voltage is about 3 V to 7 V.

4. The liquid crystal display of claim 1, wherein the second biased voltage is not equal to 0.

5. The liquid crystal display of claim 1, wherein the first biased voltage and the second biased voltage are in different polarities.

6. The liquid crystal display of claim 1, further comprising a first alignment layer disposed on the upper substrate facing the liquid crystal layer, wherein the first alignment layer has a first anchoring energy W₁, and is configured to induce vertical alignment of the liquid crystal molecules in the voltage-off state.

7. The liquid crystal display of claim 6, wherein no alignment layer is disposed on the lower substrate.

8. The liquid crystal display of claim 7, wherein the first anchoring energy W₁ is in a range of about 10⁻³ to 10⁻² N/m.

9. The liquid crystal display of claim 6, further comprising a second alignment layer disposed on the lower substrate facing the liquid crystal layer, wherein the second alignment layer has a second anchoring energy W₂, and the second anchoring energy W₂ is weaker than the first anchoring energy W₁.

10. The liquid crystal display of claim 9, wherein the first anchoring energy W₁ is in a range of about 10⁻³ to 10⁻² N/m, and the second anchoring energy W₂ is in a range of about 10⁻⁶ to 10⁻⁵ N/m.

11. A liquid crystal display, comprising:
an upper substrate and a lower substrate spaced apart from each other, forming a cell gap therebetween;
a liquid crystal layer disposed in the cell gap between the upper substrate and the lower substrate and having liquid crystal molecules;
a common electrode disposed on the lower substrate facing the liquid crystal layer;
a passivation layer disposed on the lower substrate and covering the common electrode;
a plurality of pixel electrodes disposed on the passivation layer; and
a planar electrode disposed on the upper substrate facing the liquid crystal layer, wherein the planar electrode is configured to be provided with a first biased voltage being greater than 0;
wherein the upper substrate has a first anchoring energy W₂ and the lower substrate has a second anchoring energy W₂, and the second anchoring energy W₂ is weaker than the first anchoring energy W₁.

12. The liquid crystal display of claim 11, wherein no alignment layer is disposed on the lower substrate.

13. The liquid crystal display of claim 11, wherein the liquid crystal molecules of the liquid crystal layer are vertically aligned at a voltage-off state.

14. The liquid crystal display of claim 13, being switchable from the voltage-off state to a voltage-on state by applying on-state voltages to the pixel electrodes, wherein for the pixel electrodes in the voltage-on state, the on-state voltages applied to two adjacent ones of the pixel electrodes are in different polarities.

15. The liquid crystal display of claim 11, wherein the first biased voltage is about 3 V to 7 V.

16. The liquid crystal display of claim 11, wherein the common electrode is configured to be provided with a second biased voltage, and the second biased voltage is not equal to 0.

17. The liquid crystal display of claim 11, wherein the common electrode is configured to be provided with a second biased voltage, an absolute value of the second biased voltage is smaller than an absolute value of the first biased voltage, and the first biased voltage and the second biased voltage are in different polarities.

18. The liquid crystal display of claim 17, wherein the first biased voltage is a positive voltage, and the second biased voltage is a negative voltage.

19. The liquid crystal display of claim 11, wherein a first alignment layer is disposed on the upper substrate facing the liquid crystal layer, a second alignment layer is disposed on the lower substrate facing the liquid crystal layer, the first alignment layer has the first anchoring energy W₁, and the second alignment layer has the second anchoring energy W₂.

20. The liquid crystal display of claim 11, wherein the first anchoring energy W₁ is in a range of about 10⁻³ to 10⁻² N/m, and the second anchoring energy W₂ is in a range of about 10⁻⁶ to 10⁻⁵ N/m.
